(19) United States
(12) Patent Application Publication
(10) Pub. No.: US 2026/0237552 A1
(43) Pub. Date: Aug. 13, 2026

(54) MULTILAYER COIL COMPONENT

(71) Applicant: TDK Corporation, Tokyo (JP)

(72) Inventors: So KOBAYASHI, Tokyo (JP); Yuto SHIGA, Tokyo (JP); Hiroto KOMATSU, Tokyo (JP); Teru ISHIMORI, Tokyo (JP); Takuma SAKAIYA, Tokyo (JP)

(73) Assignee: TDK Corporation, Tokyo (JP)

(21) Appl. No.: 19/464,861

(22) Filed: Jan. 30, 2026

(30) Foreign Application Priority Data
Feb. 3, 2025 (JP) 2025-015986

(51) Int. Cl. H01F 27/29; H01F 17/00

(52) U.S. Cl. CPC H01F 27/292; H01F 17/0013

(57) ABSTRACT

A multilayer coil component includes: an element body including a main surface forming a mounting surface; a coil disposed inside the element body; and a first external electrode and a second external electrode spaced apart from each other in a first direction along the main surface. The first external electrode includes a first main surface electrode portion embedded in the element body to be exposed from the main surface. The coil is connected to a first end portion of the first external electrode in a second direction intersecting the first direction and extending along the main surface. The first main surface electrode portion has a length in the first direction that monotonically decreases with increasing distance from the first end portion in the second direction.

### TECHNICAL FIELD

The present disclosure relates to a multilayer coil component. This application claims priority based on Japanese Patent Application No. 2025-015986 filed on February 3, 2025, the entire contents of which are incorporated herein by reference.

### BACKGROUND

A multilayer coil component that includes an element body, a coil disposed inside the element body, and a pair of external electrodes connected to the coil is known (e.g., see Japanese Unexamined Patent Publication No. 2017-17116). In the coil component disclosed in Japanese Unexamined Patent Publication No. 2017-17116, an L-shaped external terminal electrode is provided on a main surface and an end surface of the element body.

### SUMMARY

In the above multilayer coil component, the external electrodes and the coil are disposed facing each other. Thus, stray capacitance is generated between the external electrodes and the coil.

It is an object of the present disclosure to provide a multilayer coil component that is capable of reducing stray capacitance.

(1) A multilayer coil component according to one aspect of the present disclosure includes: an element body including a main surface forming a mounting surface; a coil disposed inside the element body; and a first external electrode and a second external electrode spaced apart from each other in a first direction along the main surface, wherein the first external electrode includes a first main surface electrode portion embedded in the element body to be exposed from the main surface, wherein the coil is connected to a first end portion of the first external electrode in a second direction intersecting the first direction and extending along the main surface, and wherein the first main surface electrode portion has a length in the first direction that monotonically decreases with increasing distance from the first end portion in the second direction.

In the above multilayer coil component, the first main surface electrode portion has a smaller size compared to a configuration in which the length of the first main surface electrode portion in the first direction does not change in the second direction and is maintained at the length at the first end portion. Thus, the facing area between the first main surface electrode portion and the coil is reduced. As a result, the stray capacitance can be reduced.

(2) In the multilayer coil component of (1) above, the element body may include a first end surface adjacent to the main surface, and the first external electrode may include a first end surface electrode portion embedded in the element body to be exposed from the first end surface. In this case, the mounting strength can be improved.

(3) In the multilayer coil component of (2) above, the first end surface electrode portion may have a length in a third direction perpendicular to the main surface that monotonically decreases with increasing distance from the first end portion in the second direction. In this case, the first end surface electrode portion has a smaller size compared to a configuration in which the length of the first end surface electrode portion in the third direction does not change in the second direction and is maintained at the length at the first end portion. Thus, the facing area between the first end surface electrode portion and the coil is reduced. As a result, the stray capacitance can further be reduced.

(4) In the multilayer coil component according to any one of (1) to (3) above, the element body may include a second end surface adjacent to the main surface and facing the first end surface in the first direction, the second external electrode may include a second main surface electrode portion embedded in the element body to be exposed from the main surface and a second end surface electrode portion embedded in the element body to be exposed from the second end surface, the coil may be connected to a second end portion of the second external electrode in the second direction, and the second main surface electrode portion may have a length in the first direction that monotonically decreases with increasing distance from the second end portion in the second direction, and the second end surface electrode portion may have a length in the third direction that decreases with increasing distance from the second end portion in the second direction. In this case, the second main surface electrode portion has a smaller size compared to a configuration in which the length of the second main surface electrode portion in the first direction does not change in the second direction and is maintained at the length at the second end portion. Thus, the facing area between the second main surface electrode portion and the coil is reduced. Additionally, the second end surface electrode portion has a smaller size compared to a configuration in which the length of the second end surface electrode portion in the third direction does not change in the second direction and is maintained at the length at the second end portion. Thus, the facing area between the second end surface electrode portion and the coil is reduced. Therefore, the stray capacitance can further be reduced.

(5) In the multilayer coil component according to any one of (1) to (4) above, the coil may include a coil axis extending along the second direction. In this case, the potential difference between the first main surface electrode portion and the coil increases with increasing distance from the first end portion in the second direction. Consequently, the facing area between the first main surface electrode portion and the coil is reduced at portions where the potential difference between the first main surface electrode portion and the coil increases due to the length of the first main surface electrode portion in the first direction monotonically decreasing with increasing distance from the first end portion in the second direction. This can effectively reduce the stray capacitance.

(6) In the multilayer coil component according to any one of (1) to (5) above, an end edge of the first main surface electrode portion in the first direction may have a stepped shape. In this case, the first main surface electrode portion can be easily formed by laminating electrode layers having different sizes.

### BRIEF DESCRIPTION OF THE DRAWINGS

FIG. 1 is a perspective view of a multilayer coil component according to an embodiment.

FIG. 2 is an exploded perspective view of the multilayer coil component of FIG. 1.

FIG. 3 is a diagram of the multilayer coil component of FIG. 1 as viewed from a side.

FIG. 4 is a diagram of the multilayer coil component of FIG. 1 as viewed from a mounting surface.

FIG. 5 is a diagram of the multilayer coil component of FIG. 1 as viewed from an end surface.

FIG. 6 is a diagram of the multilayer coil component of FIG. 1 as viewed from the end surface.

FIG. 7 is a diagram of a multilayer coil component according to a variation as viewed from the end surface.

### DETAILED DESCRIPTION

Embodiments will be described in detail below with reference to the accompanying drawings. Same reference signs are given to the same or corresponding elements in the description of the drawings, and redundant description will be omitted.

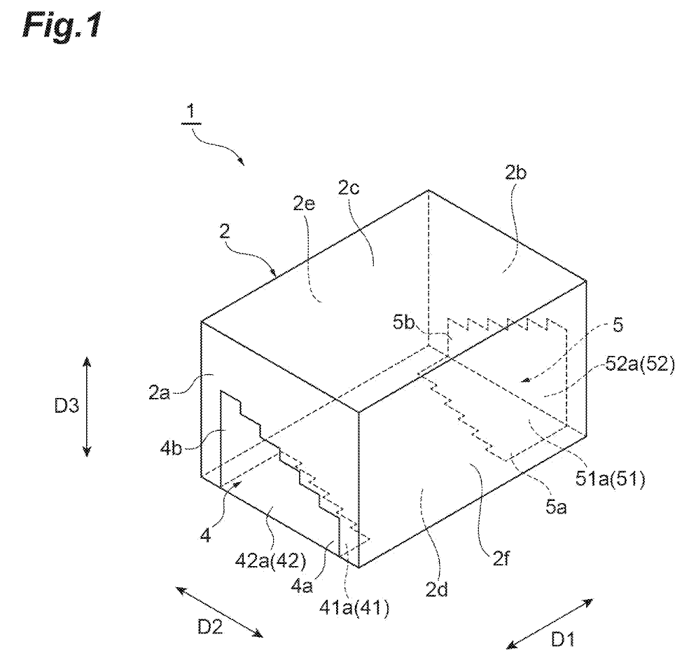

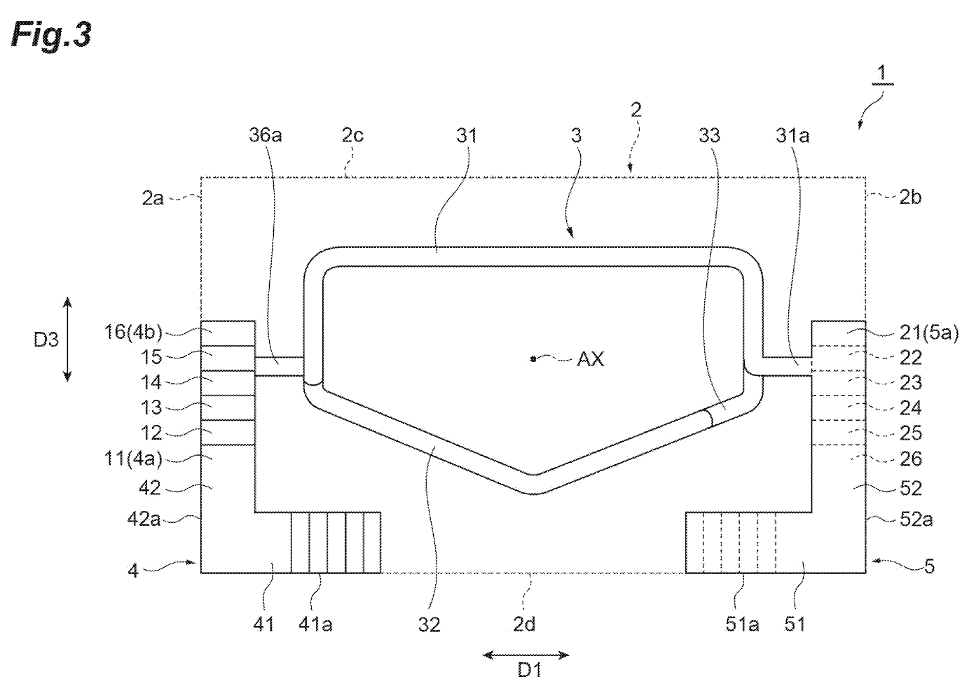

FIG. 1 is a perspective view of a multilayer coil component 1 according to an embodiment. As illustrated in this figure, the multilayer coil component 1 includes an element body 2, a coil 3 (see FIG. 3), an external electrode 4, and an external electrode 5.

The element body 2 has a rectangular parallelepiped shape. The rectangular parallelepiped shape includes a rectangular parallelepiped shape in which the corners and edges are chamfered, and a rectangular parallelepiped shape in which the corners and edges are rounded. The element body 2 includes, as its outer surfaces, end surfaces 2a, 2b that face each other, main surfaces 2c, 2d that face each other, and side surfaces 2e, 2f that face each other. In this embodiment, the main surface 2d forms a mounting surface that faces another electronic device (e.g., a circuit board or an electronic component) when the multilayer coil component 1 is mounted on the electronic device. The end surfaces 2a, 2b and the side surfaces 2e, 2f are each a surface adjacent to the mounting surface (main surface 2d.)

Hereinafter, the direction in which the end surfaces 2a, 2b face each other is referred to as a first direction D1, the direction in which the side surfaces 2e, 2f face each other is referred to as a second direction D2, and the direction in which the main surfaces 2c, 2d face each other is referred to as a third direction D3. The first direction D1, the second direction D2, and the third direction D3 intersect (herein, are perpendicular to) each other. In this embodiment, the first direction D1 is a longitudinal direction of the element body 2. The second direction D2 is a lateral direction of the element body 2. The third direction D3 is a vertical direction of the element body 2. The first direction D1 and the second direction D2 are directions along the mounting surface (main surface 2d). The first direction D1 is a direction along the long side of the mounting surface (main surface 2d). The second direction D2 is a direction along the short side of the mounting surface (main surface 2d).

In this embodiment, the element body 2 has a length in the first direction D1 (length of the element body 2) greater than a length of the element body 2 in the second direction D2 (width of the element body 2) and greater than a length of the element body 2 in the third direction D3 (height of the element body 2). That is, the main surfaces 2c, 2d and the side surfaces 2e, 2f have rectangular shapes in which the first direction D1 is the direction along the long side. The element body 2 has a length in the second direction D2 greater than a length of the element body 2 in the third direction D3, but it may be equivalent to the length of the element body 2 in the third direction D3. That is, the end surfaces 2a, 2b have a rectangular shape in which the second direction D2 is the direction along the long side, but they may have a square shape. In this specification, the term “equivalent” includes minute differences or manufacturing errors within a preset range, in addition to meaning the same. For example, if a plurality of values are included in a ±5% range of an average value of the plurality of values, the plurality of values may be considered equivalent.

The end surfaces 2a, 2b extend in the third direction D3 so as to connect the main surfaces 2c, 2d. The end surfaces 2a, 2b also extend in the second direction D2 so as to connect the side surfaces 2e, 2f. The main surfaces 2c, 2d extend in the first direction D1 so as to connect the end surfaces 2a, 2b. The main surfaces 2c, 2d also extend in the second direction D2 so as to connect the side surfaces 2e, 2f. The side surfaces 2e, 2f extend in the first direction D1 so as to connect the end surfaces 2a, 2b. The side surfaces 2e, 2f also extend in the third direction D3 so as to connect the main surfaces 2c, 2d.

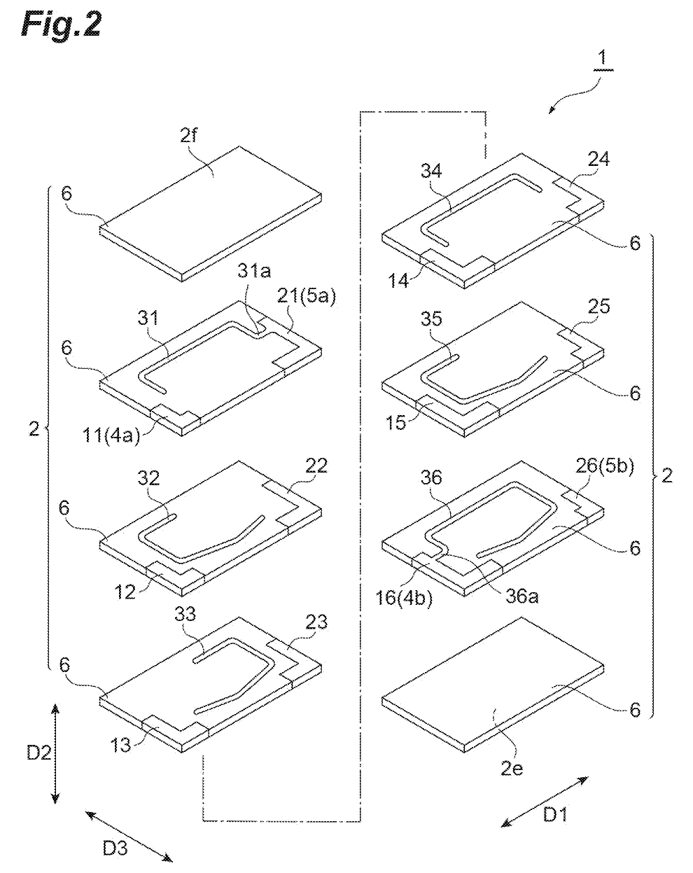

FIG. 2 is an exploded perspective view of the multilayer coil component 1 of FIG. 1. As illustrated in this figure, the element body 2 is formed by a plurality of dielectric layers 6 (insulating layers) being laminated in a direction in which the side surfaces 2e, 2f face each other (second direction D2). In the element body 2, a lamination direction of the plurality of dielectric layers 6 (hereinafter also simply referred to as the “lamination direction”) coincides with the second direction D2. The dielectric layer 6 that is disposed at one end in the lamination direction has a surface that forms the side surface 2e. The dielectric layer 6 that is disposed at the other end in the lamination direction has a surface that forms the side surface 2f.

Each dielectric layer 6 is formed of a sintered body of a ceramic green sheet including, for example, a dielectric material (dielectric ceramics such as BaTiO₃-based, Ba(Ti, Zr)O₃-based, or (Ba, Ca)TiO₃-based dielectric ceramics). In an actual element body 2, the dielectric layers 6 are integrated such that the boundaries between the dielectric layers 6 cannot be visually recognized.

FIG. 3 is a diagram of the multilayer coil component 1 of FIG. 1 as viewed from the side surface 2f. In this figure, the element body 2 is illustrated in broken lines to show the inner structure of the element body 2. As illustrated in this figure, the coil 3 is disposed inside the element body 2 and is not exposed from the element body 2. The coil 3 has a coil axis AX along the second direction D2. The coil axis AX extends along the second direction D2. The coil axis AX is provided parallel to the main surface 2d which is the mounting surface. A direction of extension of the coil axis AX coincides with the lamination direction. The coil 3 has an annular or frame-like shape (in this embodiment, an annular or frame-like pentagonal shape) when viewed in the second direction D2.

As illustrated in FIGS. 2 and 3, the coil 3 includes coil conductors 31, 32, 33, 34, 35, 36 (hereinafter, coil conductors 31 to 36). The coil 3 is formed by the coil conductors 31 to 36 being electrically connected. The coil conductors 31 to 36 are directly connected to each other without through-hole conductors. The coil conductors 31 to 36 are arranged in order along the second direction D2. The coil conductor 31 is disposed closest to the side surface 2f. The coil conductor 36 is disposed closest to the side surface 2e.

The coil conductor 31 has one end portion of the coil 3 and is connected to the external electrode 5 by a connection portion 31a. The connection portion 31a is integrally formed with the coil conductor 31. The coil conductor 36 has the other end portion of the coil 3 and is connected to the external electrode 4 by a connection portion 36a. The connection portion 36a is integrally formed with the coil conductor 36.

The coil conductors 31 to 36 include a conductive material (e.g., Ag or Pd). The coil conductors 31 to 36 are formed as sintered bodies of a conductive paste including the above conductive material. The coil conductors 31 to 36 are provided on different dielectric layers 6 from each other. Each of the coil conductors 31 to 36 extends through the corresponding dielectric layer 6. Each of the coil conductors 31 to 36 has a thickness in the second direction D2 that is equivalent to a thickness of the corresponding dielectric layer 6 in the second direction D2. The coil conductors 31 to 36 are not disposed on the dielectric layers 6 positioned at both ends in the lamination direction. Accordingly, the coil 3 is not exposed on the side surfaces 2e, 2f.

The external electrodes 4, 5 are connected to the coil 3. The external electrodes 4, 5 are spaced apart from each other in the first direction D1. The external electrodes 4, 5 face each other in the first direction D1. The external electrode 4 is disposed on the end surface 2a side of the element body 2. The external electrode 5 is disposed on the end surface 2b side of the element body 2. The external electrodes 4, 5 have portions that overlap each other when viewed in the first direction D1. The external electrodes 4, 5 have an L-shape when viewed in the second direction D2.

The external electrode 4 has an electrode portion 41 (first main surface electrode portion) and an electrode portion 42 (first end surface electrode portion). The electrode portion 41 is embedded in the element body 2 so as to be exposed from the main surface 2d. The electrode portion 42 is embedded in the element body 2 so as to be exposed from the end surface 2a. The electrode portions 41, 42 are connected to each other at the edge portion between the end surface 2a and the main surface 2d of the element body 2. The electrode portions 41, 42 are electrically connected to each other. The external electrode 4 is spaced apart from the end surface 2b, the main surface 2c, and the side surfaces 2e, 2f.

The electrode portion 41 extends in the first direction D1 and the second direction D2. The electrode portion 41 has an exposed surface 41a that is exposed from the main surface 2d. The exposed surface 41a is coplanar with the main surface 2d. The electrode portion 42 extends in the third direction D3 and the second direction D2. The electrode portion 42 has an exposed surface 42a that is exposed from the end surface 2a. The exposed surface 42a is coplanar with the end surface 2a. The exposed surfaces 41a, 42a are connected to each other at the edge portion between the end surface 2a and the main surface 2d of the element body 2.

The external electrode 5 has an electrode portion 51 (second main surface electrode portion) and an electrode portion 52 (second end surface electrode portion). The electrode portion 51 is embedded in the element body 2 so as to be exposed from the main surface 2d. The electrode portion 52 is embedded in the element body 2 so as to be exposed from the end surface 2b. The electrode portions 51, 52 are connected to each other at the edge portion between the end surface 2b and the main surface 2d of the element body 2. The electrode portions 51, 52 are electrically connected to each other. The external electrode 5 is spaced apart from the end surface 2a, the main surface 2c, and the side surfaces 2e, 2f.

The electrode portion 51 extends in the first direction D1 and the second direction D2. The electrode portion 51 has an exposed surface 51a that is exposed from the main surface 2d. The exposed surface 51a is coplanar with the main surface 2d. The electrode portion 52 extends in the third direction D3 and the second direction D2. The electrode portion 52 has an exposed surface 52a that is exposed from the end surface 2b. The exposed surface 52a is coplanar with the end surface 2b. The exposed surfaces 51a, 52a are connected to each other at the edge portion between the end surface 2b and the main surface 2d of the element body 2.

As illustrated in FIG. 2, the external electrode 4 includes electrode layers 11, 12, 13, 14, 15, 16 (hereinafter, electrode layers 11 to 16) that are laminated in the second direction D2. In an actual external electrode 4, the electrode layers 11 to 16 are integrated such that the boundaries between the electrode layers cannot be visually recognized. The electrode layers 11 to 16 are arranged in order along the second direction D2. The electrode layer 11 is disposed closest to the side surface 2f and forms an end portion 4a of the external electrode 4 in the second direction D2. The electrode layer 16 is disposed closest to the side surface 2e and forms an end portion 4b (first end portion) of the external electrode 4 in the second direction D2. The coil 3 is connected to the end portion 4b by the connection portion 36a. The end portion 4b is a connection portion with the coil 3.

The external electrode 5 includes electrode layers 21, 22, 23, 24, 25, 26 (hereinafter, electrode layers 21 to 26) that are laminated in the second direction D2. In an actual external electrode 5, the electrode layers 21 to 26 are integrated such that the boundaries between the electrode layers cannot be visually recognized. The electrode layers 21 to 26 are arranged in order along the second direction D2. The electrode layer 21 is disposed closest to the side surface 2f and forms an end portion 5a (second end portion). The electrode layer 26 is disposed closest to the side surface 2e and forms an end portion 5b. The coil 3 is connected to the end portion 5a by the connection portion 31a. The end portion 5a is a connection portion with the coil 3.

The electrode layers 11 to 16 and the electrode layers 21 to 26 include a conductive material (e.g., Ag or Pd). The electrode layers 11 to 16 and the electrode layers 21 to 26 are formed as sintered bodies of a conductive paste including the above conductive material. Each of the electrode layers 11 to 16 and the electrode layers 21 to 26 extends through the corresponding dielectric layer 6. Each of the electrode layers 11 to 16 and the electrode layers 21 to 26 has a thickness in the second direction D2 that is equivalent to the thickness of the corresponding dielectric layer 6 in the second direction D2. In this embodiment, the external electrodes 4, 5 are formed of the same conductive material as the coil 3. The electrode layers 11 to 16, the electrode layers 21 to 26, and the coil conductors 31 to 36 are formed by co-firing.

The electrode layers 11, 21 are provided on the same dielectric layer 6 as the coil conductor 31. The electrode layers 12, 22 are provided on the same dielectric layer 6 as the coil conductor 32. The electrode layers 13, 23 are provided on the same dielectric layer 6 as the coil conductor 33. The electrode layers 14, 24 are provided on the same dielectric layer 6 as the coil conductor 34. The electrode layers 15, 25 are provided on the same dielectric layer 6 as the coil conductor 35. The electrode layers 16, 26 are provided on the same dielectric layer 6 as the coil conductor 36.

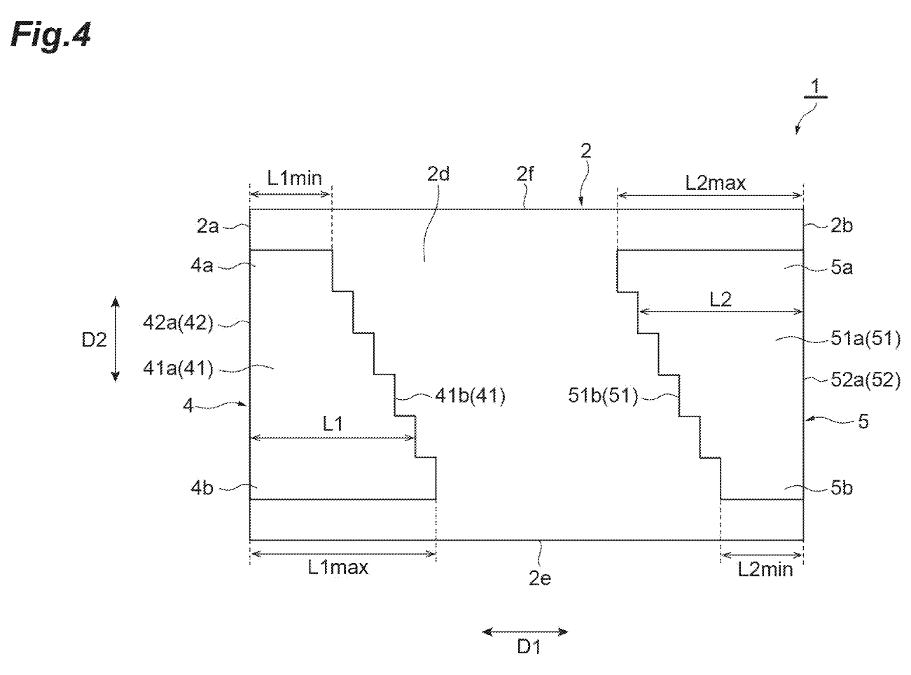

FIG. 4 is a diagram of the multilayer coil component 1 of FIG. 1 as viewed from the mounting surface (main surface 2d). As illustrated in this figure, the electrode portion 41 (exposed surface 41a) has a length L1 in the first direction D1 that monotonically decreases with increasing distance from the end portion 4b in the second direction D2. As used herein, “monotonically decreasing” means non-increasing and means a monotonic decrease in a broad sense. That is, a maximum value L1max of the length L1 is a length of the end portion 4b (electrode layer 16) in the first direction D1, and a minimum value L1min of the length L1 is a length of the end portion 4a (electrode layer 11) in the first direction D1. It can be said that an end edge 41b of the exposed surface 41a in the first direction D1 has no inflection point.

In this embodiment, the electrode layers 11 to 16 have a length in the first direction D1 that decreases stepwise by a predetermined amount from the electrode layer 16 toward the electrode layer 11. Accordingly, the end edge 41b has a stepped shape. Here, the step heights of the plurality of steps are equal to each other and the spacings between the plurality of steps are equal to each other.

The electrode portion 51 (exposed surface 51a) has a length L2 in the first direction D1 that monotonically decreases with increasing distance from the end portion 5a in the second direction D2. That is, a maximum value L2max of the length L2 is a length of the end portion 5a (electrode layer 21) in the first direction D1, and a minimum value L2min of the length L2 is a length of the end portion 5b (electrode layer 26) in the first direction D1. It can be said that an end edge 51b of the exposed surface 51a in the first direction D1 has no inflection point.

In this embodiment, the electrode layers 21 to 26 have a length in the first direction D1 that decreases stepwise by a predetermined amount from the electrode layer 21 toward the electrode layer 26. Accordingly, the end edge 51b has a stepped shape. Here, the step heights of the plurality of steps are equal to each other and the spacings between the plurality of steps are equal to each other.

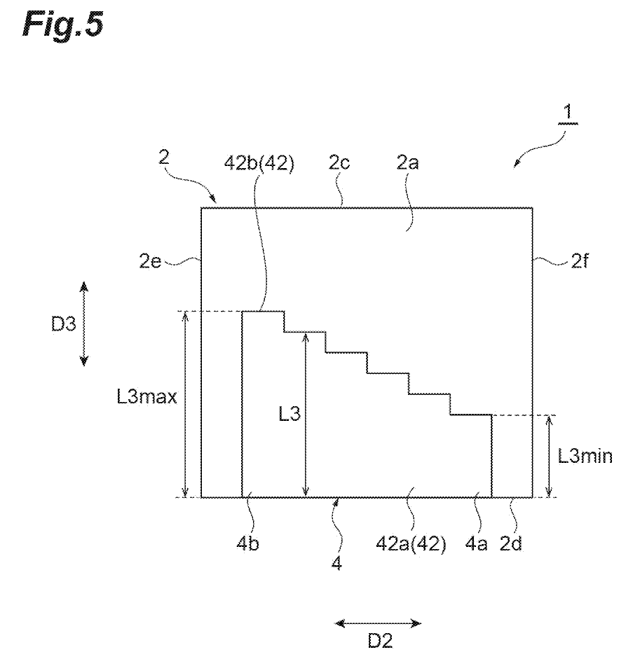

FIG. 5 is a diagram of the multilayer coil component 1 of FIG. 1 as viewed from the end surface 2a. As illustrated in this figure, the electrode portion 42 (exposed surface 42a) has a length L3 in the third direction D3 that monotonically decreases with increasing distance from the end portion 4b in the second direction D2. That is, a maximum value L3max of the length L3 is a length of the end portion 4b (electrode layer 16) in the third direction D3, and a minimum value L3min of the length L3 is a length of the end portion 4a (electrode layer 11) in the third direction D3. It can be said that an end edge 42b of the exposed surface 42a in the third direction D3 has no inflection point.

In this embodiment, the electrode layers 11 to 16 have a length in the third direction D3 that decreases stepwise by a predetermined amount from the electrode layer 16 toward the electrode layer 11. Accordingly, the end edge 42b has a stepped shape. Here, the step heights of the plurality of steps are equal to each other and the spacings between the plurality of steps are equal to each other.

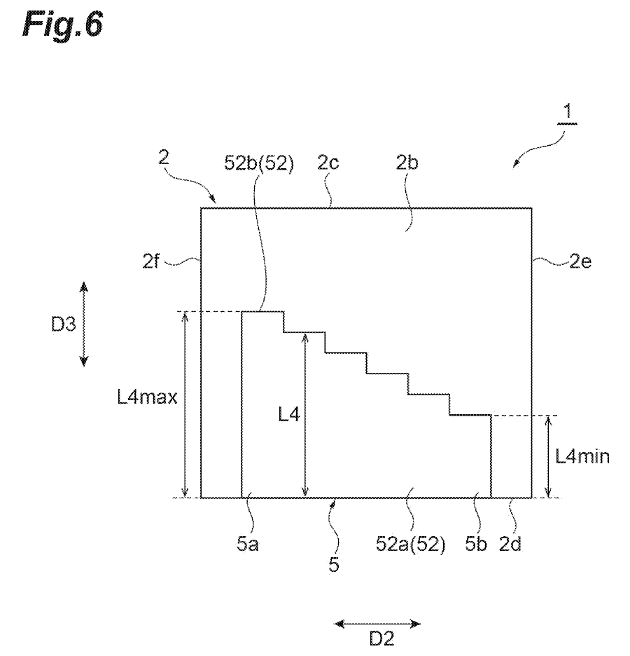

FIG. 6 is a diagram of the multilayer coil component 1 of FIG. 1 as viewed from the end surface 2b. As illustrated in this figure, the electrode portion 52 (exposed surface 52a) has a length L4 in the third direction D3 that monotonically decreases with increasing distance from the end portion 5a in the second direction D2. That is, a maximum value L4max of the length L4 is a length of the end portion 5a (electrode layer 21) in the third direction D3, and a minimum value L4min of the length L4 is a length of the end portion 5b (electrode layer 26) in the third direction D3. It can be said that an end edge 52b of the electrode portion 52 (exposed surface 52a) in the third direction D3 has no inflection point.

In this embodiment, the electrode layers 21 to 26 have a length in the third direction D3 that decreases stepwise by a predetermined amount from the electrode layer 21 toward the electrode layer 26. Accordingly, the end edge 52b has a stepped shape. Here, the step heights of the plurality of steps are equal to each other and the spacings between the plurality of steps are equal to each other.

As described above, in the multilayer coil component 1, the length L1 of the electrode portion 41 in the first direction D1 monotonically decreases with increasing distance from the end portion 4b in the second direction D2. The electrode portion 41 has a smaller size compared to a configuration in which the length L1 does not change in the second direction D2 and is maintained at the maximum value L1max even at portions other than the end portion 4b. Thus, the facing area between the electrode portion 41 and the coil 3 is reduced. As a result, the stray capacitance generated between the electrode portion 41 and the coil 3 can be reduced.

The length L2 of the electrode portion 51 in the first direction D1 monotonically decreases with increasing distance from the end portion 5a in the second direction D2. The electrode portion 51 has a smaller size compared to a configuration in which the length L2 does not change in the second direction D2 and is maintained at the maximum value L2max even at portions other than the end portion 5a. Thus, the facing area between the electrode portion 51 and the coil 3 is reduced. As a result, the stray capacitance generated between the electrode portion 51 and the coil 3 can be reduced.

The length L3 of the electrode portion 42 in the third direction D3 monotonically decreases with increasing distance from the end portion 4b in the second direction D2. The electrode portion 42 has a smaller size compared to a configuration in which the length L3 does not change in the second direction D2 and is maintained at the maximum value L3max even at portions other than the end portion 4b. Thus, the facing area between the electrode portion 42 and the coil 3 is reduced. As a result, the stray capacitance generated between the electrode portion 42 and the coil 3 can be reduced.

The length L4 of the electrode portion 52 in the third direction D3 monotonically decreases with increasing distance from the end portion 5a in the second direction D2. The electrode portion 52 has a smaller size compared to a configuration in which the length L4 does not change in the second direction D2 and is maintained at the maximum value L4max even at portions other than the end portion 5a. Thus, the facing area between the electrode portion 52 and the coil 3 is reduced. As a result, the stray capacitance generated between the electrode portion 52 and the coil 3 can be reduced.

The coil 3 has the coil axis AX along the second direction D2. Accordingly, the potential difference between each of the electrode portions 41, 42 and the coil 3 increases with increasing distance from the end portion 4b in the second direction D2. Therefore, the facing area between each of the electrode portions 41, 42 and the coil 3 is reduced at portions where the potential difference between each of the electrode portions 41, 42 and the coil 3 increases. Consequently, the stray capacitance generated between each of the electrode portions 41, 42 and the coil 3 can be effectively reduced. Additionally, the mounting strength can be maintained at the portions where the potential difference between each of the electrode portions 41, 42 and the coil 3 decreases, since the size of each of the electrode portions 41, 42 is maintained.

Similarly, the potential difference between each of the electrode portions 51, 52 and the coil 3 increases with increasing distance from the end portion 5a in the second direction D2. Therefore, the facing area between each of the electrode portions 51, 52 and the coil 3 is reduced at portions where the potential difference between each of the electrode portions 51, 52 and the coil 3 increases. Consequently, the stray capacitance generated between each of the electrode portions 51, 52 and the coil 3 can be effectively reduced. Additionally, the mounting strength can be maintained at the portions where the potential difference between each of the electrode portions 51, 52 and the coil 3 decreases, since the size of each of the electrode portions 51, 52 is maintained.

The end edges 41b, 42b of the external electrode 4 have a stepped shape. Thus, the external electrode 4 can be easily formed by laminating the electrode layers 11 to 16 having different sizes. The end edges 51b, 52b of the external electrode 5 have a stepped shape. Thus, the external electrode 5 can be easily formed by laminating the electrode layers 21 to 26 having different sizes.

Although the embodiments have been described above, the present disclosure is not necessarily limited to these embodiments, and various modifications are possible without departing from the gist thereof.

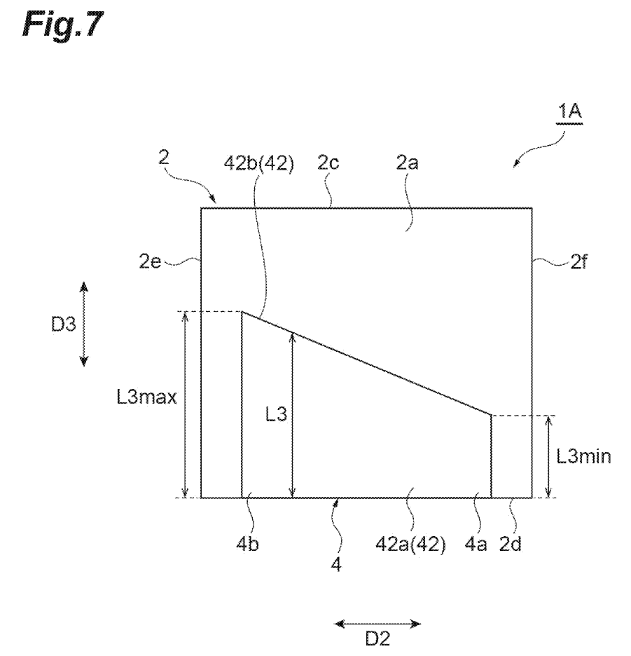

FIG. 7 is a diagram of a multilayer coil component according to a variation as viewed from the end surface 2a. As illustrated in this figure, in a multilayer coil component 1A according to the variation, the end edge 42b of the electrode portion 42 (exposed surface 42a) extends as a single straight line inclined with respect to the second direction D2. Although not shown, the end edges 41b, 51b, 52b may extend as single straight lines inclined with respect to the second direction D2.

Although not shown, the end edges 41b, 42b, 51b, 52b may have a stepped shape in which at least one step height of the plurality of steps is different from the other step heights. The end edges 41b, 42b, 51b, 52b may have a stepped shape in which at least one spacing between the plurality of steps is different from the other spacings.

In the multilayer coil components 1, 1A, the external electrode 4 may have only the electrode portion 41 without having the electrode portion 42. In this case, the electrode portion 41 may be provided on the main surface 2d so as to be spaced apart from the end surface 2a. The external electrode 5 may have only the electrode portion 51 without having the electrode portion 52. In this case, the electrode portion 51 may be provided on the main surface 2d so as to be spaced apart from the end surface 2b.

In the multilayer coil components 1, 1A, it is only required that the length L1 monotonically decreases with increasing distance from the end portion 4b in the second direction D2, and for example, the lengths L2, L3, L4 need not change in the second direction D2.

In the multilayer coil components 1, 1A, the coil axis AX of the coil 3 may be provided along the first direction D1 or along the third direction D3.

The embodiments and variations described above may be combined as appropriate.

What is claimed is:

1. A multilayer coil component comprising:
an element body including a main surface forming a mounting surface;
a coil disposed inside the element body; and
a first external electrode and a second external electrode spaced apart from each other in a first direction along the main surface,
wherein the first external electrode includes a first main surface electrode portion embedded in the element body to be exposed from the main surface,
wherein the coil is connected to a first end portion of the first external electrode in a second direction intersecting the first direction and extending along the main surface, and
wherein the first main surface electrode portion has a length in the first direction that monotonically decreases with increasing distance from the first end portion in the second direction.

2. The multilayer coil component according to claim 1,
wherein the element body includes a first end surface adjacent to the main surface, and
wherein the first external electrode includes a first end surface electrode portion embedded in the element body to be exposed from the first end surface.

3. The multilayer coil component according to claim 2,
wherein the first end surface electrode portion has a length in a third direction perpendicular to the main surface that monotonically decreases with increasing distance from the first end portion in the second direction.

4. The multilayer coil component according to claim 3,
wherein the element body includes a second end surface adjacent to the main surface and facing the first end surface in the first direction,
wherein the second external electrode includes a second main surface electrode portion embedded in the element body to be exposed from the main surface and a second end surface electrode portion embedded in the element body to be exposed from the second end surface,
wherein the coil is connected to a second end portion of the second external electrode in the second direction, and
wherein the second main surface electrode portion has a length in the first direction that monotonically decreases with increasing distance from the second end portion in the second direction, and the second end surface electrode portion has a length in the third direction that monotonically decreases with increasing distance from the second end portion in the second direction.

5. The multilayer coil component according to claim 1,
wherein the coil includes a coil axis extending alogn the second direction.

6. The multilayer coil component according to claim 1,
wherein an end edge of the first main surface electrode portion in the first direction has a stepped shape.

7. The multilayer coil component according to claim 1,
wherein the first external electrode includes a plurality of electrode layers laminated in the second direction.

8. The multilayer coil component according to claim 7,
wherein the plurality of electrode layers have lengths in the first direction that decrease stepwise from the first end portion toward a second end portion of the first external electrode opposite to the first end portion in the second direction.

9. The multilayer coil component according to claim 8,
wherein step heights of the plurality of electrode layers are equal to each other, and spacings between the plurality of electrode layers are equal to each other.

10. The multilayer coil component according to claim 1,
wherein an end edge of the first main surface electrode portion in the first direction extends as a straight line inclined with respect to the second direction.

11. The multilayer coil component according to claim 1,
wherein the element body includes a plurality of dielectric layers laminated in the second direction,
wherein the coil includes a plurality of coil conductors provided on different dielectric layers among the plurality of dielectric layers, and
wherein the plurality of coil conductors are electrically connected to each other.

12. The multilayer coil component according to claim 11,
wherein the plurality of coil conductors are directly connected to each other without through-hole conductors.

13. The multilayer coil component according to claim 11,
wherein the first external electrode and the plurality of coil conductors contain the same conductive material.

14. The multilayer coil component according to claim 1,
wherein the coil includes a connection portion integrally formed with a coil conductor constituting an end of the coil, and
wherein the connection portion is connected to the first end portion of the first external electrode.

15. The multilayer coil component according to claim 1,
wherein the first main surface electrode portion includes an exposed surface exposed from the main surface, and
wherein the exposed surface is coplanar with the main surface.

16. The multilayer coil component according to claim 1,
wherein an end edge of the first main surface electrode portion in the first direction has no inflection point.
